(19) United States
(12) Patent Application Publication
(10) Pub. No.: US 2008/0008844 A1
(43) Pub. Date: Jan. 10, 2008

(54) METHOD FOR GROWING ARRAYS OF ALIGNED NANOSTRUCTURES ON SURFACES

(76) Inventors: Martin Bettge, Urbana, IL (US); Stephan Burdin, Mahomet, IL (US); Scott MacLaren, Champaign, IL (US); Ivan Petrov, Champaign, IL (US); Ernie Sammann, Urbana, IL (US)

Correspondence Address: GREENLEE WINNER AND SULLIVAN P C, 4875 PEARL EAST CIRCLE, SUITE 200, BOULDER, CO, 80301, US

(21) Appl. No.: 11/758,448

(22) Filed: Jun. 5, 2007

Related U.S. Application Data
(60) Provisional application No. 60/811,033, filed on Jun. 5, 2006.

(51) Int. Cl. H05H 1/24

(52) U.S. Cl. 427/576; 427/578

(57) ABSTRACT

The invention provides methods for growing an array of elongated nanostructures projecting from a surface. The nanostructures of the array are aligned substantially perpendicularly to the surface. In one aspect of the invention, the diameter of the nanostructures is between 10 nm and 200 nm. The methods of the invention can produce nanostructure growth at temperatures less than 350 degrees Celsius. Alignment of the nanostructures does not rely on epitaxial growth from a single crystal substrate, allowing a variety of substrates to be used.

### CROSS-REFERENCE TO RELATED APPLICATIONS

This application claims the benefit of U.S. Provisional Application 60/811,033, filed Jun. 5, 2006, which is hereby incorporated by reference to the extent not inconsistent with the disclosure herein.

### ACKNOWLEDGEMENT OF GOVERNMENT SUPPORT

This invention was made with Government support under Contract Number DEFG02-91-ER45439 awarded by the U.S. Department of Energy (DOE). The Government has certain rights in the invention.

### BACKGROUND OF THE INVENTION

This invention is in the field of synthesis of elongated nanostructure such as nanowires and nanowhiskers. In one aspect, the invention provides methods of synthesizing aligned arrays of conductor, semiconductor, insulator, or carbon-based nanostructures.

The vapor-liquid-solid (VLS) process is well known as a method of growing microscopic whiskers on substrates. Gold droplets have been used as a VLS catalyst for many years and were adapted for silane precursor gases and nanoscale growth (U.S. Pat. No. 5,858,862). Sunkara et al. (Sunkara, M. K. et al, 2001, Appl. Phys. Left., 79(10), 1546-1548) report bulk synthesis of silicon nanowires using gallium as the molten solvent in a microwave generated hydrogen plasma. U.S. Pat. No. 6,806,228 to Sharma et al. also relates to low temperature synthesis of semiconductor fibers. Kim et al. reports growth of silicon nanowires by a mechanism involving NiSi formation (Kim, J. et al., 2004, Mat. Res. Soc. Symp. Proc. Vol. 818, paper M11.11). U.S. Pat. No. 6,831,017 to Li et al. relates to methods for forming a plurality of catalyst sites from which to grow nanowires. U.S. Patent Application Publication no. 2006/0057360 to Samuelson et al. reports nanostructures formed of branched nanostructures by a two stage VLS process. U.S. Pat. No. 6,882,051 to Majumdar et al. report nanowire heterostructures synthesized using a modified VLS procedure. Fan (Shoushan Fan, et al., 1999, Science, 283, 512-514) and Andrews (R. Andrews, 1999, Chemical Physics Letters, 303, 467-474) discuss carbon nanotube orientation in densely growing bundles. Merkulov (Vladimir I. Merkulov, 2001, Applied Physics Letters 79(8), 1178-1180) discusses alignment mechanisms for arrays of well-separated carbon nanotubes grown at 700 degrees Celsius, reporting aligned growth only when catalyst droplets are present at the tips of the nanotubes. Dzbanovsky (N. N. Dzbanovsky, 2006, Microelectronics Journal, 36, 634-638) reports aligned growth of partially oxidized silicon nanowires above 800 degrees Celsius; the tips were reported to be free of catalyst. Shi (Wen-Sheng Shi, 2000, Advanced materials, 12(18), 1343-1345) describes the growth of dense, oriented bundles of partially oxidized silicon nanowires at 930 degrees Celsius without catalyst. U.S. Patent Application Publication no. 2007/0095276 to Sunkara et al. reports growth of various nanowires at temperatures as low as 30 degrees Celsius via dissolution of solutes in metal droplets. Sunkara et al. suggest placement of metal droplets in 2-D and 3-D channels to obtain directed growth.

There remains a need in the art for improved methods for growing aligned nanowires, nanocones, and nanotubes which do not require high temperatures or expensive substrate preparation techniques.

### SUMMARY OF THE INVENTION

In an embodiment, the invention provides methods for growing an array of elongated nanostructures projecting from a surface. In an embodiment, the elongated nanostructures are in the form of a nanowire or nanocone. In an embodiment, the elongated nanostructures are aligned substantially perpendicular to the surface. The density of the projections can be on the order of hundreds of millions per square centimeter. This array structure provides a large active surface area for chemical applications (e.g. as battery or ultracapacitor electrodes). In addition, the arrays of the invention can be useful for solar applications. The nanostructures may be made of a variety of materials including, but not limited to, semiconductors, oxides, nitrides, carbides and combinations thereof.

In an embodiment, an array formed by one of the methods of the invention can be used as a support or template on which other materials can be deposited. In an embodiment, the additional deposition step(s) can be performed using apparatus and methods similar to those used to synthesize the arrays but under differing reaction conditions. The capability to use the same apparatus can provide both a productivity advantage and a potential safety improvement, in that workers will have a reduced risk of exposure to nanostructures having the narrowest widths and highest aspect ratios if these structures are widened in situ.

In an embodiment, the methods of the invention involve nanostructure growth via an ion-assisted Vapor-Liquid-Solid (VLS)-type mechanism. In an aspect of the invention, droplets of liquid metal on the substrate surface initialize or mediate the growth of the nanostructures from vapor phase reactants. The nanostructures start growing at the substrate-liquid metal interface. As the nanostructures continue to grow, the liquid metal droplets lift off the substrate, supported only at the tips of the growing projections. In an embodiment, the mediating material has a melting temperature less than about 350 degrees Celsius, which enables the use of relatively inexpensive substrate materials.

In an embodiment, the droplets of liquid metal are formed by melting a thin layer of a mediating material formed on the substrate surface. The degree of wetting between the substrate and the molten mediating material is such that, the molten mediating material spontaneously forms droplets on the substrate surface. In an embodiment, the droplets are randomly arrayed. In an embodiment, the droplet diameters are fairly uniform, closely related to the thickness of the original metal layer and influenced by the wetting angle. In an embodiment, the layer is not patterned; distribution of the mediating material over the substrate thus does not require expensive lithographic techniques. In other embodiments, the layer may be patterned using patterning techniques known to those skilled in the art.

The vapor phase reactants may be provided in atomic form or as precursor compounds which dissociate to provide the required elements. For example, sputtered Si atoms and silane are both suitable vapor phase reactants for growth of silicon-containing nanostructures.

In an embodiment, directional growth of the nanostructures does not require epitaxial growth from a single-crystal substrate. In an embodiment, the methods of the invention are not affected by minor surface irregularities and imperfections of the surface, so elaborate and expensive surface substrate preparations are not needed.

In an embodiment, the invention provides a method of synthesizing an array of aligned elongated nanostructures, the method comprising the steps of:
a) providing a substrate in a vacuum chamber;
b) forming a layer of mediating material on a surface of the substrate, wherein the mediating material, when molten, forms droplets on the substrate surface, and the melting temperature of the mediating material is less than 350° C.;
c) heating said substrate and the mediating material to a temperature sufficient to melt the mediating material in a vacuum atmosphere, the atmosphere comprising a component which is selected from the group consisting of noble gases, nitrogen and combinations thereof; and
d) synthesizing aligned elongated nanostructures of a selected chemical composition at the mediating material droplets, the nanostructures extending up from the substrate surface and being located generally under the mediating material droplets by
   i) providing a source of each chemical element of the selected composition;
   ii) generating a plasma in the vacuum chamber, thereby forming plasma species including positive ions; and
   iii) inducing a negative electric potential on the substrate relative to the plasma, thereby directing positive ions towards the substrate surface.

In another embodiment, the invention provides a method of synthesizing an array of aligned elongated nanostructures, the structures being aligned at a selected angle with respect to the substrate surface, the method comprising the steps of:
a) providing a substrate in a vacuum chamber;
b) forming a layer of mediating material on a surface of the substrate, wherein the mediating material, when molten, forms droplets on the substrate surface;
c) heating the substrate and the mediating material to a temperature sufficient to melt the mediating material in a vacuum atmosphere, the atmosphere comprising a component which is selected from the group consisting of noble gases, nitrogen and combinations thereof; and
d) synthesizing aligned elongated nanostructures of a selected chemical composition at the mediating material droplets, the nanostructures extending up from the substrate surface and being located generally under the mediating material droplets by
   i) providing a source of each chemical element of the selected composition; and
   ii) directing an ion beam at said substrate surface, said beam having ion energies in the range of 10 eV to 5 keV.

In one aspect of the invention, the longitudinal axes of the nanostructures of the array are generally perpendicular to the substrate surface. In another embodiment, the longitudinal axis of the structures is aligned at an angle other than 90 degrees with respect to the substrate plane.

### BRIEF DESCRIPTION OF THE FIGURES

FIG. 1 illustrates the size and distribution of indium droplets formed after melting of an indium layer formed on a silicon wafer with the native oxide remaining (after solidification of the droplets).

FIG. 2 illustrates the appearance of the substrate at an early stage in silicon nanowire growth. The metal mediating material particles are clearly visible on top of the silicon nanowires.

FIG. 3 illustrates silicon nanocones formed at a later stage of the process than that shown in FIG. 2.

FIG. 4 is a normal incidence view of nanocones of the sample shown in FIG. 3.

FIG. 5 is a top view of nanocones viewed from an angle of 30 degrees from normal incidence which have been processed with a subsequent silicon sputter deposition step, assisted by ion bombardment.

FIG. 6 is a view of another set of nanocones processed with a subsequent sputter deposition step, assisted by ion bombardment.

FIG. 7 is a view of an additional set of nanocones processed with a subsequent sputter deposition step, assisted by ion bombardment.

### DETAILED DESCRIPTION OF THE INVENTION

In an embodiment, the methods of the invention are suitable for making elongated nanostructures. In different embodiments, the elongated nanostructures may be nanowires, nanocones, nanowhiskers or nanotubes. In an embodiment, the nanostructures do not have a hollow interior. In another embodiment, the nanostructures do have a hollow interior. In different embodiments, the nanostructures may have cross-sections that are circular, or that are faceted, or that appear to have no single preferred shape.

These elongated nanostructures are of nanometer dimensions in their width or diameter, having a maximum width or diameter between about 1 nm and about 1 micron. In other embodiments, the width or diameter of the nanostructures of the invention is between about 2 nm and about 1 micron, between about 10 nm and about 400 nm, between 20 nm and about 300 nm or between about 50 nm and about 200 nm. Nanowires, nanorods, nanowhiskers, and nanotubes are also sometimes referred to as “one-dimensional” nanostructures. In one embodiment, the diameter of the nanostructures is substantially constant along the length of the nanostructure. In another embodiment, the nanostructures are tapered in a tip region, but the diameter of the nanostructures is constant to within about 25% or 20% away from the tip region. In another embodiment, the diameter of the nanostructures varies along the length of the nanostructure. In an embodiment, the diameter of the nanostructures is greater at the base of the nanostructure (at the substrate end) than at the tip of the nanostructure.

The nanostructures are provided in the form of an array. In different embodiments, the density of the nanostructures is between 1 and 10,000 per micron squared, between 4 and 100 per micron squared, between 1 and 5 per micron squared, and between 10 and 50 per micron squared. The nanostructures of the array are generally aligned. Perfect alignment is not required. In an embodiment, the variation in nanostructure alignment is between /−4 and +/−6 degrees. In another embodiment, the variation is +/−4 to +/−40 degrees. The nanostructures may be aligned substantially perpendicular to the surface or at a selected angle with respect to the surface.

The nanostructures of the array may be homogeneous or inhomogeneous in chemical composition. For example, an inhomogeneous nanostructure may comprise a first material at least partially coated with one or more shells or layers of one or more additional materials. Unless a particular portion of the nanostructure is referred to, the chemical composition of a nanostructure refers to the overall chemical composition of the nanostructure. The nanostructures may be made of a variety of types of materials. In different embodiments, the nanostructures may be formed of a semiconductor, a doped semiconductor, or a more heavily alloyed semiconductor. Exemplary semiconductors include, but are not limited to, silicon and compound semiconductors. The nanostructures may also be formed of an oxide, a carbide, or a nitride. Exemplary oxides, carbides, and nitrides include, but are not limited to, SiO₂, SiC and Si₃N₄. In other embodiments, a shell of an oxide, a carbide, or a nitride may be formed over a nanostructure which does not contain substantial amounts of oxide, carbide, or nitride (e.g. SiO₂ over Si) or vice versa (Si over SiO₂). In different embodiments, the nanostructures may or may not be of carbon.

The nanostructures may be crystalline, amorphous or a combination thereof. Crystalline semiconducting materials include single crystal materials, nanocrystalline materials, and polycrystalline materials. In another embodiment, the nanostructures are nanocrystalline as synthesized. In an embodiment, the nanostructures can be annealed to increase the crystallinity of the structure.

In the methods of the invention, at least one surface of the substrate is suitable for vapor-liquid-solid (VLS)-type growth of the selected material or chemical composition. In an embodiment, the surface of the substrate may be formed by a coating applied to an underlying support. In other embodiments, one or more underlying layers may be formed on the underlying support.

For growth of silicon-containing elongated nanostructures, the surface may be silicon or silicon with a native oxide layer. Either type of surface will generally allow mediating material droplets of suitable size to be produced during the melting step. However, the interaction between the substrate and the mediating material is critical to the methods of this invention, so some choices of mediating material may require special choices of substrate surface. A silicon surface may be obtained by using a silicon wafer as a substrate, or by depositing a film of silicon onto another substrate material. Suitable substrate surfaces for carbon-containing nanostructures include Si or native Si oxide on silicon as well as various carbon coatings.

In one aspect of the invention, an “intermediate layer” is deposited onto an underlying support. In an embodiment, the intermediate layer is of substantially the same material as the support (e.g. a silicon layer on a silicon support), but has a different crystalline structure than the underlying support. In another embodiment, the intermediate layer has chemical composition related to that of underlying support, but the level of surface oxidation is different (e.g. the oxide layer on a silicon intermediate layer is either thinner or not present while the silicon support has a native oxide layer). In another embodiment, the intermediate layer has a substantially different chemical deposition than the support. In this embodiment, the process conditions may be selected to minimize sputtering of the intermediate layer when material from the intermediate layer would contaminate the growing nanostructures. In an embodiment, the intermediate layer is composed of silicon, and no special treatment of the film is needed to assure a particular crystal structure or orientation. Typically the intermediate layer is a few hundreds of nanometers thick. The film may be amorphous, nanocrystalline or polycrystalline depending on the deposition conditions. The intermediate layer provides a well-controlled surface for the critical mediating material deposition step to follow, and may be selected to promote the formation of nanodroplets of the mediating material, as well as to control nucleation of the selected material upon the intermediate layer during the earliest stages of growth. It also provides a barrier which prevents contamination of the nanostructure growth process by the support material and damage to the support by the nanostructure growth process. When the exposed intermediate layer is not being used as a feedstock for nanostructure growth, the net rate of growth vs. etching for the intermediate layer is nearly zero, so a very thin layer is adequate for most functions. The underlying support material (as well as any layers deposited above the support) must be able to survive temperatures on the order of the melting temperature of the mediating material. In an embodiment, the underlying support material can withstand temperatures of roughly 120 to 350 degrees Celsius without melting or giving off significant vapor (i.e. the material must be vacuum-compatible at the process temperature). Suitable underlying support materials include metals, polymers, glasses and ceramics. In an embodiment, the support material is electrically conductive. In an embodiment, the underlying support is steel, the intermediate layer is silicon, and the intermediate layer can be directly deposited onto the support by magnetron sputtering in argon. In some cases, it may be desirable to deposit a thin (a few nanometers to tens of nanometers) interface or adhesion layer between the underlying support and the intermediate layer to improve bonding. For example, the use of a thin titanium or chromium layer is well known as a method of improving adhesion of thin gold films to glass. Additional intermediate layers to serve as diffusion barriers might be needed if prolonged exposure to high temperatures would be expected. For example, a variety of materials are used in the semiconductor industry to isolate copper from silicon in integrated circuits to avoid the formation of copper silicide. In another embodiment, a thin “release” layer can be applied to the underlying support prior to the intermediate layer deposition. After synthesis, the release layer can be dissolved away to free the intermediate layer above and the attached nanostructures. In an embodiment, the compositions of the nanostructures, the intermediate layer, and the release layer are chosen to facilitate removal of the release layer without destruction of the nanolayers. In an embodiment, the nanostructure formation process includes the step of depositing the intermediate layer on the support after the support is placed in the vacuum chamber. Methods for deposition of intermediate layer films such as silicon are well known to those skilled in the art, and include, but are not limited to magnetron sputter deposition, evaporation, chemical vapor deposition, and the like.

The mediating material facilitates the VLS-like process. In an embodiment, the mediating material is selected so that it does not form stable reactant-rich phases at reactant concentrations experienced in the growth environment, and has low solubility in the nanowire or nanotube material. Therefore, the mediating material is not substantially consumed during growth of the nanotubes or nanowires. However, if the mediating material is to be used to dope the nanostructure, a limited amount of solubility is desirable. Typically, the mediating material is a metal. In an embodiment, suitable metals for use as mediating materials include, but are not limited to, indium, tin, gallium, bismuth, aluminum, mercury, cadmium, lead, thallium gold, zinc, tellurium, lithium, sodium, potassium and combinations thereof. In an embodiment, the metal is selected from the group consisting of indium, tin, gallium, bismuth, aluminum and alloys thereof. In another embodiment, the metal is selected from the group consisting of indium, tin, gallium, bismuth, and alloys thereof. In an embodiment, the initial composition of the mediating material is pure indium. An indium containing mediating material may be used in combination with a silicon intermediate layer. During the synthesis process, the composition of the mediating material will typically change as it takes the reactants into solution. In an embodiment, the thickness of the film of mediating material is 10-30 nm. The film thickness determines the droplet size. In an embodiment, the size of the droplets is between 50 nm and about 200 nm. In an embodiment, for indium films approximately 20 nm thick, the initial droplet size is approximately 100 nm. After a droplet array has formed, it can continue to ripen, evolving into an array of larger, less numerous droplets. Ripening occurs most quickly during ion irradiation, but virtually halts when growth begins and the droplets lift off the surface. Controlled ripening allows deliberate reduction of the resulting nanostructure density, a useful feature for some applications. Methods for mediating material layer deposition include any suitable method known to those skilled in the art, including, but not limited to vacuum evaporation and sputter deposition. For thermal evaporation, the material must be heated to allow significant vapor pressure. In an embodiment, the vacuum environment provides a pressure low enough to prevent condensation of the evaporant into clusters or droplets before it reaches the sample.

In an embodiment, the mediating material is selected so that it provides the desired doping of the nanostructure. For example, use of indium as the mediating material can provide p-doping of silicon. The mediating material can also be selected to provide doping of semiconductor layers deposited on top of the nanostructures.

The substrate is heated in order to melt the metal mediating layer. The substrate may be heated by any method known to the art, including by a lamp, resistive heating, or from the plasma (ion or electron induced heating). In different embodiments, the substrate temperature is heated to a temperature less than 400° C., less than or equal to 350° C., or less than or equal to 250° C., between 150 and 250° C., or approximately 200° C.

In an embodiment, the substrate is heated in a vacuum atmosphere. In an embodiment, the total pressure in the vacuum chamber is between about 10 mTorr and about 40 mTorr or about 30 mTorr. In other embodiments, the pressure is from 10 mTorr to 200 mTorr, from 30 mTorr to 200 mTorr, or from 40 mTorr to 150 mTorr, or from 30 to 100 mTorr. Depending on the particular synthesis method, the atmosphere in the vacuum chamber may comprise one or more components selected from plasma forming components, feedstock components which provide sources of elements used to form the nanostructures, and etching components. Any of these components may be a gas mixture. For example, the etching component may be mixture of an etchant such as hydrogen with a relatively inert gas such as argon.

A source of each element of the selected nanostructure composition is provided in the reactant chamber. In an embodiment, sputtered atoms provide one or more elements of the nanostructure composition. Typically, the sputtered atoms are produced through interaction of a plasma with a solid target material. For example, the source of silicon can be silicon atoms produced by magnetron sputtering of a silicon target. The growth of compounds may be accomplished through the use of compound targets, or by the use of elemental targets in a suitably reactive plasma environment. The plasma can also be used to remove features and atoms on the substrate.

In another embodiment, a vapor phase precursor decomposes to form at least some of the desired elements of the nanostructure. For example, the source of silicon can be silane, a gaseous compound of silicon and hydrogen. Under stimulation from the electrical discharge near the substrate, silane can decompose at the liquid metal droplets, leaving silicon behind. The silicon tends to join the growing projections rather than remain in the liquid metal. In an embodiment, the silane is part of a gas mixture which comprises hydrogen and may further comprise other gases. In an embodiment, at least some of the silane comes from sources other than etching of the substrate or silicon features on the substrate. In an embodiment, the silane precursor can be obtained by passing hydrogen through a plasma column with a large exposed silicon surface area under ion bombardment. By controlling the rate of gas flow and the plasma intensity in the silane-generating column, the silane concentration can be controlled, and thus the ratio of growth to etching of the nanostructures. A gas phase environment for carbon nanostructures can be easily created by bubbling a carrier gas (e.g. Ar) through a liquid hydrocarbon (e.g. benzene) or through use of a hydrocarbon gas. Sources for carbon-containing materials include hydrocarbon gases such as methane. In addition, for formation of silicon carbide, a combination of silicon and carbon sources can be used.

In another embodiment, additional “doping” elements are introduced into the vacuum chamber so that they are incorporated into the nanostructure as it grows. The doping elements may be introduced by introduction of suitable gases or by any other method known to those skilled in the art. Doping can occur during initial synthesis of the nanostructures or during later deposition steps. For example, p-doping of silicon can be achieved by incorporating group III elements such as indium, gallium, boron or aluminum into the nanostructure, while n-doping can be achieved by incorporating group V elements such as phosphorus, or antimony. Doping of semiconductors is well known to those skilled in the art.

Without wishing to be bound by any particular belief, the aligned growth is believed to occur through an ion-assisted modified VLS mechanism. Growth of the nanostructures can occur through a VLS-type mechanism at the droplets or islands of mediating material. More than one nanostructure can be grown from a single droplet. In an embodiment, two to a few nanostructures are grown from each droplet. In an embodiment, addition of material to the sidewalls of the nanostructures during the synthesis process can also contribute to the overall growth of the nanostructures. For example, when sputtered atoms contribute to the nanostructure growth, some of the sputtered atoms may be deposited on the sidewalls and cause thickening of the nanostructure while other sputtered atoms are incorporated into the nanostructures through the mediating material.

Ion bombardment of the samples is believed to contribute both to growth and alignment of the structures. In fact, in an embodiment, ion bombardment from an ion gun can be the sole directing influence for aligned growth of the nanostructures. Ion bombardment can influence reactivity and adsorption rates at surfaces (as in ion-assisted CVD). For example, ion irradiation can provide the energy needed to promote reactions on the droplet surfaces (especially involving gas phase precursors), as well as within the droplets, that would not otherwise occur because of the low substrate temperature. Ion irradiation can also stimulate diffusion. In addition, any material removed from the substrate by sputtering can contribute to growth of the nanostructures through its incorporation into the structures. Ion irradiation can play a particularly significant role in the production of aligned arrays of widely-spaced nanostructures; that is, those for which the spacing between the nanostructures is too large (nanostructure density is too low) to support the alignment mechanisms described by Fan (1999) and Andrews (1999) as mediated by “crowding” or van der Waals forces.

Ion irradiation can contribute to alignment through several mechanisms; the synthesis conditions will determine the operative mechanism(s). In an embodiment, ion irradiation can lead to etching of the nanostructures; selective etching of the nanostructures can assist in alignment of the structures. Without wishing to be bound by any particular theory, it is believed that nanostructure projections not aligned with the ion bombardment can be shaped by etching and sidewall growth until they are aligned; otherwise they etch away by a process similar to reactive ion etching. In an embodiment, the ions bombarding the sample are well aligned and have relatively high energies. In one embodiment, the ions extracted through the plasma sheath towards the substrate bombard the substrate surface at a near normal angle of incidence. For a hydrogen-containing plasma, these positive ions include hydrogen ions, which are very light. The liquid metal mediating droplets are believed to be largely unaffected by hydrogen bombardment, and therefore can shield nanostructures which have grown beneath them and are aligned with the bombardment. However, nanostructure projections that are not aligned with the ion bombardment tend to be shaped by etching and sidewall growth until they are aligned; otherwise they etch away by a process similar to reactive ion etching. . If heavier ions such as argon are present in the plasma, these ions can also bombard the sample. In this case, the liquid metal droplets can be affected by the ion bombardment and the mediating material can gradually be sputtered away. This etching process can be particularly helpful for the removal of structures that have lost their mediating metal and have ceased to grow, or have, for any reason, collapsed onto the substrate. Gases other than hydrogen are known to the art for reactive ion etching of various materials (Anner, G. E., Planar Processing Primer (1990), Van Nostrand Reinhold, New York).

The alignment of the nanostructures can also be influenced by the bombardment of the exposed surfaces of the mediating material droplets. Without wishing to be bound by any particular theory, it is believed that bombardment of the mediating material droplets by ions and fast neutrals can stimulate mixing, suppress nucleation, influence the relative supersaturation of the concealed and exposed surfaces of the droplets, and/or transfer momentum to errant nuclei and their projections, pushing them around the liquid droplet to the shaded side. The close proximity of the substrate assures that there will be a large difference in ion and fast neutral fluxes between the concealed and exposed surfaces of the droplets even where the angular distribution of the incident flux is very broad, as it may be when the mean free path is quite short with respect to the plasma sheath. In an embodiment, the alignment of the nanostructures is assisted by relatively intense bombardment of the mediating metal with ions and fast neutral particles of relatively low energies. When alignment control can be implemented by this means, the loss of mediating material by sputter etching may be reduced, and taller nanostructures may be grown. In other embodiments, both the ion etching scheme and the low energy bombardment scheme are used to control alignment, either simultaneously through a suitable choice of conditions, or sequentially, allowing the advantages of each to be employed during different phases of the growth process.

In an embodiment, irradiation of the mediating material and the substrate is accomplished by a combination of positively charged ions from a plasma and also by “fast neutrals” from a plasma. Fast neutrals are here defined as neutral atoms that are directed toward the substrate with energies exceeding 20 times the characteristic thermal energy of the neutral gas comprising the plasma. That characteristic thermal energy is given by the product of the Boltzman constant and the absolute temperature of the neutral gas. Fast neutrals may be generated by collisions between accelerated ions and neutral atoms or neutral molecules within the plasma sheath region surrounding the substrate.

In an embodiment, the average impact energy of ions striking the substrate surface during synthesis of the nanostructures is on the order of at least 5 eV. Under some conditions, this energy may be sufficient to provide some radiation-induced mixing at the mediating material surface. In an embodiment, the average impact energy of ions striking the substrate surface during synthesis of the nanostructures is on the order of at least 10 eV. It is believed that reactive etching can be obtained with an impact energy of 10 eV or so in a hydrogen-containing plasma, but there may be enough thermal energy in the hydrogen component of the plasma that a 10 eV beam extracted from the plasma will not be adequately collinear. That is, such a beam may have considerable lateral momentum, and may etch sidewalls of tall structures excessively, so higher impact energies may be desirable.

In other embodiments, the average impact energy of ions striking the substrate surface during synthesis of the nanostructures is on the order of at least 50 eV, 100 eV, 200 eV, 500 eV, 1.0 keV, 1.5 keV, 2.0 keV or 2.5 keV. In other embodiment, the average impact energy is from 50 eV to 1.5 keV, from 50 eV to 1.0 keV, from 50 eV to 500 eV, or from 50 eV to 200 eV. For structures with high aspect ratios, a highly collinear beam of ions is most able to affect the shapes of the structures over their entire lengths.

The average impact energy of ions striking the substrate surface during subsequent deposition on the nanostructures can also affect the resulting structure. In an embodiment, lower bombardment energies can lead to concentration of deposition at the tips of the nanostructures while higher bombardment energies can lead to deposition over a greater length of the nanostructure.

In one embodiment of the invention, the ions are supplied by a plasma generated in the vacuum chamber. In this aspect of the invention, a negative electric potential is imposed on the substrate relative to the plasma. The energy with which ions will bombard the substrate surface will depend in part upon the difference between the plasma potential and the substrate potential. In different embodiments, the applied potential is from 50 V to 1.5 kV, from 50 V to 1 kV, from 50 V to 500 V, from 50 V to 150 V, from 500 V to 1.5 kV or from 500 V to 1.0 kV.

The negative electric potential can be applied to the substrate using a power supply electrically connected between the substrate and the chamber, or between the substrate and other suitable electrodes within the chamber, or may 20 be induced by the application of a radio-frequency (RF) potential onto the substrate with respect to other electrodes within the chamber. The principles of RF substrate bias are well known to those practiced in the art, and may be found in standard references (see appendix C-3 in Anner, G. E., Planar Processing Primer (1990), Van Nostrand Reinhold, New York). However, simply applying a voltage does not necessarily result in directed impact energy if collisions disrupt the trajectories of the attracted ions. For the full difference between the substrate potential and the plasma potential to appear as directed impact energy, the pressure must be low enough and the plasma sheath thin enough that collisions seldom occur as ions are accelerated from the plasma through the sheath and onto the substrate. Often, particularly as gas pressure is increased, this condition is not met, and charge-exchange collisions occur frequently in the sheath region, reducing the impact energies of particles striking the substrate, but increasing their numbers. This can be advantageous for obtaining intense low-energy bombardment of the mediating metal, as discussed above.

Without wishing to be bound by any particular belief, it is believed that in some embodiments, the potential applied between the substrate and the plasma can also influence the alignment of the growth through the influence of electrostatic forces upon the nanostructures. The application of a potential between the substrate and the plasma can result in mechanical forces that may act to extend the nanostructure in the direction of the field (see Poncharal, et al., 1999, Science, 283, 1513-1516). Since the field at the substrate surface is generally oriented parallel to the surface normal vector, the nanostructures, if mechanically compliant, will tend to extend along that direction. In addition to stretching out the already-grown nanostructure, this may influence the direction of ongoing growth (see Vladimir I. Merkulov, 2001, Applied Physics Letters 79(8), 1178-1180, also N. N. Dzbanovsky, 2006, Microelectronics Journal, 36, 634-638). In an embodiment, additional etching and deposition occur along the sides of the nanostructures while they are in this extended state and the stiffness of the added material helps to maintain the elongated state after the bias is removed. In another embodiment, ion and fast neutral irradiation of the extended nanostructures also serves to anneal them, so that, by the end of the processing period, the relaxed state of the nanostructures has become similar to the extended state existing under bias.

In an embodiment, the plasma is generated from a gas mixture comprising one or more noble gases, nitrogen, or combination thereof. In this embodiment, the noble gas, nitrogen, or combination thereof comprise the majority of the gas mixture. In different embodiments, the noble gas is argon, neon, or helium or combinations thereof. The gas may be chosen on the basis of its expected threshold energy for sputtering of the mediating material.

Other gases may also be present in the mixture, either as impurities or deliberately added to the mixture. Water vapor is typically the major constituent of residual vacuum in unbaked vacuum systems. In a system with a base pressure of 8×10⁻⁷ torr, the water vapor partial pressure may typically be as high as 5×10⁻⁷ torr. Water vapor may also be deliberately added. In an embodiment, the amount of water vapor added is below that at which the sputtering target and sample surfaces start to become oxidized. For example, water vapor may be present in quantities less than 1%, than 0.5% or about 0.1%. In another embodiment, the water vapor pressure is less than 1×10⁻⁴ torr, or about 1×10⁻⁵ torr. In another embodiment, a silicon dioxide sputtering target is used in addition to the water vapor. The addition of water to the gas mixture can increase the fraction of droplets that yield elongated nanostructures and also increase the average growth rate of the projections. The concentration of water vapor may be adjusted depending on the growth rate, with lower concentrations being employed at lower growth rates and higher concentrations at higher growth rates.

In an embodiment, the plasma is generated from a gas mixture comprising hydrogen and an inert gas such as argon. In different embodiments, the percentage of hydrogen in a hydrogen/argon mixture is between 5% and 15% or about 10%. In another embodiment, the gas mixture comprises hydrogen, a noble gas, and water vapor. In another embodiment, hydrogen is not deliberately added to the gas mixture and is present only in trace amounts.

In another embodiment, the gas mixture comprises nitrogen as a minor component in combination with a noble gas such as argon.

In an embodiment, argon is the major constituent of the plasma environment, indium or tin is used as the mediating metal, and the average impact energy of the ions is selected to be less than 1.4 keV. In another embodiment, argon is the major constituent of the plasma environment, indium is used as the mediating metal, and the average impact energy of the ions is less than 200 eV. In another embodiment, helium is the major constituent of the plasma environment, indium or tin is used as the mediating metal, and the average impact energy of the ions is less than 200 eV.

To compensate for the sputtering of the mediating metal which can occur at the substrate, mediating material can be co-deposited or sequentially deposited with the nanostructure material. For example, half of a silicon magnetron surface can be covered with an indium foil, resulting in the co-deposition of indium and silicon. In another embodiment, separate magnetrons are used for each element. For example, rotating or otherwise sequenced shutters can be used over the magnetrons, the depositions performed cyclically, and the sample bias applied only during the phase when both magnetrons are covered.

A variety of techniques are known in the art for forming plasmas, including injecting beams of microwaves and introducing magnetic or electric fields into a low pressure gas. In an embodiment, the plasma is not generated via microwaves. In an embodiment, the plasma is generated by applying a potential difference between electrodes. The substrate potential may or may not significantly excite the plasma. Any reactor configuration known to the art may be used, including diode and triode reactors. In an embodiment, the plasma is formed by a sputtering source in which the cathode is a target of the material to be sputtered. In magnetron sputtering sources, one or more magnets provide a magnetic field in the vicinity of the cathode surface. In this configuration, the side walls of the system can act as the anode. In an embodiment, a magnetic field is arranged in the vicinity of the substrate, serving to enhance the plasma density in the plasma region from which ions are extracted to bombard the sample, thus increasing the attainable bombardment flux for a given pressure and substrate potential. In another embodiment, a planar hollow cathode geometry is employed. For example, two substrates may be placed opposite each other, separated by a distance on the order of a few times the mean free path. With both substrates biased quite negatively with respect to the nearby chamber walls, a planar hollow cathode will be formed, allowing larger discharge currents (hence more rapid growth rates) than an isolated wafer can support. Magnetic fields may again be used to increase the plasma density in the region near the samples. In this configuration, silicon and indium removed from one sample will likely land on the other, reducing waste as the growth proceeds. The feedstock can be Si predeposited on the wafer or silane in the gas phase, or both. Gas chemistry can include silane, Ar as a diluent, and H₂. Note that the two substrates can be sections of a continuous web (or two webs) passing through a reaction zone, and each can pass over a large-radius, temperature controlled roller or sliding surface to provide the almost-planar conditions desired.

In an embodiment, the substrate and growing nanostructures are bombarded by an ion beam. In an embodiment, the ion beam is provided by an ion gun. In an embodiment, the ion beam comprises ions selected from the group consisting of H, He, Li, N, O, Ne, Na, Ar. In different embodiments, the ion beam provides hydrogen ions or helium ions. The beam divergence, measured as the ratio of the mean lateral ion velocity to the mean longitudinal ion velocity at impact Is preferably less than or equal to the aspect ratio (base radius divided by height) of the nanostructures to be grown. During growth of the nanostructures, the pressure in the vacuum chamber is continuously maintained such that the mean free path of the ions is on the order of, and preferably at least ten times larger than, the distance traversed by the ions in passing from the ion source to the substrate surface. The higher the pressure, the greater the likelihood of collisions disrupting the trajectories of the ions. In this embodiment, suitable sources of the selected material include a layer of the selected material deposited on the substrate prior to deposition of the mediator layer. The selected material will then be sputtered by the ion beam and provide a source of the selected material for incorporation into the nanostructures. Alternately, an evaporator can be used to provide the selected material continuously during growth. If the ion gun is located sufficiently close to the substrate a low pressure of a precursor gas can supply the selected material without obstructing the ion flux with excessive collisions. If material is supplied by an evaporator or from a precursor, the pressure in the vacuum chamber is an important parameter. The action of the ion beam may be stopped when the desired height of nanostructures is reached, or when the coating of selected material on the substrate surface has been exhausted.

In another embodiment, the ions may be obtained by ion extraction from a slot in the wall of an inductively coupled plasma (ICP). The wall allows separation between the large RF fields in the ICP section and the ion acceleration section facing the substrate (Stumpe, E. et al., 1979, Appl. Phys. 20, 55-60).

The length and morphology of the nanostructures depends on the process conditions. When the ions are able to sputter the mediating material, sputtering of the mediating material particles can limit the length of the nanowires which can be obtained. Sputtering of the mediating material can also be reduced by adjusting the sputtering conditions, including the plasma composition and the potential applied to the substrate. Longer nanowires can be obtained when mediating metal is co-deposited with the nanostructures. Codeposition of mediating metal with the feedstock (e.g. silicon) can also result in the formation of nanocones, rather than cylindrical nanowires. Codeposition of more mediating metal can result in broader and stouter cones. The shape of the nanostructures is also influenced by the amount of deposition along the sidewalls of the nanostructures during synthesis.

In an embodiment, the invention provides a method of synthesizing an array of aligned elongated nanostructures of a selected material, the structures being aligned at a selected angle with respect to the substrate surface. In an embodiment, alignment of the structures at an angle other than 90° to the substrate surface can be achieved by use of ion and/or source fluxes which are not aligned normal to the growth surface. In an embodiment, alignment of the structures is achieved by directing an ion beam along an axis chosen to coincide with the desired alignment axis of the nanostructures.

In an embodiment, the growth rate of the nanostructures is from 1 nm/min to about 1000 nm/min. Typically, the growth rate is on the order of 100 to 200 nm/min.

If desired, any mediating metal remaining at the top of the nanostructure can be sputtered away in a subsequent process step. For example, ions of an inert gas such as argon can be generated in the plasma and used for sputtering. As another example, hydrogen ions with sufficiently high energy can be used to sputter away the mediating material. Other ions, such as silane ions, can also be used. The metal can also be removed by other techniques such as chemical etching or reactive ion etching. Under some growth conditions or combinations of mediating materials and selected compositions of nanostructures, mediating material can be made to be incorporated within the growing structures. Other methods of mediating material removal include chemical vapor or plasma etching, as occurs, for example, when tin is exposed to hydrogen or hydrogen-containing vapors within the plasma, forming volatile tin hydrides.

In an embodiment, the nanostructure arrays of the invention can be modified by addition of material on the nanostructures. Chemical vapor deposition or physical vapor deposition techniques may be used. In one aspect of the invention, any remaining droplets of mediating material are not removed before this deposition step. In an embodiment, the mediating material is held at a temperature below the melting temperature before further deposition processing. In another aspect of the invention, the mediating material is removed from the nanostructures before further deposition processing or the mediating material is held at a temperature below the melting temperature before further deposition processing. In another aspect of the invention, the vacuum atmosphere is controlled so that reactive etching is minimized during further deposition. In an embodiment, the hydrogen content in the gas environment is negligible. In an embodiment, the additionally deposited material may be amorphous.

The additional deposition may form a complete or nearly complete layer of material on the nanostructures. In an embodiment, the nanostructures are not joined by the additionally deposited material, except perhaps at their bases, near the substrate. In this embodiment, the resulting structure also has the form of an array of nanostructures, although the resulting nanostructures may have a different shape than that of the initially synthesized nanostructures. For example, deposition may occur along the length of the nanostructures to form a conformal or nearly conformal coating on the nanostructures. In another embodiment, deposition may be distributed mainly toward the upper portion of the nanostructures. For example, silicon-containing nanocones can be made more cylindrical in shape by depositing an additional silicon layer such that silicon is preferentially deposited toward the upper portion of the nanocones. In another embodiment, the resulting structures are wider near their tips than near the substrate. In an embodiment, the process conditions are controlled to maintain an approximately fixed ratio between the average volume occupied by the nanostructures and the average volume represented by the voids between them.

In an additional embodiment, array nanostructures can be conjoined by the additionally deposited material. The additional deposition step may have the effect of filling in the remaining space between nanostructures. In another embodiment, localization of deposited material at the tops of the nanostructures can join the tops of the taller nanowires, resulting in a structure in which nanostructures span the space between two continuous but separate surfaces, forming a roof, pillar, and floor structure. In an embodiment, a release layer of a first chemical composition is deposited as a film upon the support. An intermediate layer of a second composition is then deposited upon the release layer. Elongated nanostructures of a third composition are then synthesized upon the intermediate layer by the methods of this invention, and subsequent deposition of additional material (also of the third composition) may be performed to join the taller nanostructures at their tips. If the composition of the release layer is suitably selected, it can be etched away without affecting the other materials, leaving the roof, pillar, and floor structure separated from the support. In an embodiment, the second and third compositions just described are the same, and the resulting roof, pillar, and floor structure consists of a single composition. In another embodiment, the second and third chemical compositions are selected to provide etch selectivity, permitting the intermediate layer to be removed from the nanostructures without damage to the nanostructures or the material connecting them at their tips. For example, compound nanowires can be synthesized over a silicon intermediate layer, or silicon nanowires over a compound intermediate layer. The removal of the intermediate layer will also free all nanostructures that were too short to be connected by the “roof” of additional deposited material, allowing them to be flushed away. The remaining nanostructures are then joined only by the roof. This “inversion” procedure can be useful to obtain nanostructures that terminate on a common plane when the initially formed nanostructures are of different heights and the deposited layer is of substantially uniform thickness. In another embodiment, this same result is obtained by a simplified process in which no release layer is used, but the intermediate layer is the support itself, and it is etched away from the nanostructures in the final step.

In an embodiment, the composition of the initially synthesized nanostructures and the later deposited material is substantially the same. In another embodiment, the composition of the initially synthesized nanostructures and at least some of the additionally deposited material is not the same. In an embodiment, nanostructures having regions of different composition can be obtained by growing a first nanostructure having a first composition and then depositing one or more layers or coatings having a different composition on top of the first nanostructure. Again, chemical vapor deposition or physical vapor deposition techniques may be used. In an embodiment, the process further comprises the step of depositing a coating of a second chemical composition on the nanostructures synthesized via the ion-assisted VLS process. For example, the first nanostructure may be a p-doped silicon nanocone and the layer undoped silicon. The subsequent nanostructure can be subjected to further processing to convert the layer to n-doped silicon. For example, a dopant material can be deposited on the outside of the layer and then diffused into the layer. The resulting nanostructure contains a p-n junction. In another embodiment, an array of p-n junctions may be formed on a array of non-semiconducting nanostructures (e.g. oxide nanostructures) by further deposition of silicon on the nanostructure array and appropriate doping of this additionally deposited silicon

As another example, a layer of an electrically insulating material may be formed over the surfaces of the nanostructured thin film. This layer may have passivating functions. For a silicon nanostructured thin film, the layer can be formed by oxidation of the silicon surface. Suitable oxidation methods include, but are not limited to, ozone oxidation. Ozone oxidation produces a very high quality self-limiting oxide a few nanometers thick. Silicon oxidation can be performed at relatively low temperatures (250° C.) in the presence of 172 nm light from an xenon excimer lamp (Boyd, I. W. et al., 1997, Mat. Res. Soc. Symp. Proc. Vol 470, 343-354).

In an embodiment, further deposition may be achieved by simply changing the synthesis conditions in the same apparatus used to make the initial array of nanostructures. In an embodiment, the mix and specific nature of deposition and bombardment are changed to become more favorable for thickening the structures. For a system employing a plasma to supply ions and sputtered target atoms to the substrate, these changes in synthesis conditions can include, but are not limited to, changing the gas pressure (which may change the angular distribution and energies of arrival of both the species being deposited and bombarding the growth surface), changing the gas composition (which may change etching and deposition rates, among other factors), changing the rate of arrival of the depositing species, changing the rate of arrival of the bombarding species (which may include ions and fast neutral particles), changing the potentials of the substrate and/or any sources of energetic particles within the deposition system (which may affect both bombardment and deposition rates, energies, and directions), changing the geometry of the growth apparatus (e.g. moving a magnetron deposition source closer to or farther from the substrate), and changing magnetic fields within the apparatus (e.g., altering the strength of a magnetic field at the substrate, thus changing the density of the plasma in the substrate vicinity).

In an embodiment, the amount of ion bombardment applied to the sample during or after any added deposition can influence the resulting structure. For example, if the sample bombardment current is relatively low, redistribution of the sputtered target atoms arriving at the tips of the nanostructure can be reduced, leading to concentration of deposition at the top of the nanostructure. Higher sample bombardment currents can result in greater redistribution of the target atoms, which may, under some conditions, promote more uniform deposition along the lengths of the nanostructures and maintain their separation. In addition, relatively high ion bombardment energies can result in sharply pointed nanostructure tips.

The final deposition step may have the effect of filling in the remaining space between the coated or uncoated nanostructures. For example, an electrically insulating layer such as a silicon oxide layer may be deposited or grown on the nanowires to form electrical insulation and provide mechanical stability. Such a layer can also serve to seal off the nanostructures from the environment and passivate any semiconductor surfaces below. After such a final deposition step, a planarizing etch may be applied to the resulting structure to expose the tips of the nanostructures as desired. Planarization can be achieved by sputtering, chemical-mechanical polishing, chemical etching, or other suitable techniques as known to those skilled in the art.

All patents and publications mentioned in the specification are indicative of the levels of skill of those skilled in the art to which the invention pertains. References cited herein are incorporated by reference herein in their entirety to indicate the state of the art, in some cases as of their filing date, and it is intended that this information can be employed herein, if needed, to exclude (for example, to disclaim) specific embodiments that are in the prior art. For example, when a method is claimed, it should be understood that methods known in the prior art, including certain methods disclosed in the references disclosed herein (particularly in referenced patent documents), are not intended to be claimed. All references cited herein are hereby incorporated by reference to the extent that there is no inconsistency with the disclosure of this specification. Some references provided herein are incorporated by reference herein to provide details concerning additional starting materials, additional methods of synthesis, additional methods of analysis and additional uses of the invention.

One skilled in the art would readily appreciate that the present invention is well adapted to carry out the objects and obtain the ends and advantages mentioned, as well as those inherent therein. The methods and accessory methods described herein as presently representative of preferred embodiments are exemplary and are not intended as limitations on the scope of the invention. Changes therein and other uses will occur to those skilled in the art, which are encompassed within the spirit of the invention, are defined by the scope of the claims.

Although the description herein contains many specificities, these should not be construed as limiting the scope of the invention, but as merely providing illustrations of some of the embodiments of the invention. Thus, additional embodiments are within the scope of the invention and within the following claims.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. Any recitation herein of the term “comprising”, particularly in a description of components of a composition or in a description of elements of a device, is understood to encompass those compositions and methods consisting essentially of and consisting of the recited components or elements. The invention illustratively described herein suitably may be practiced in the absence of any element or elements, limitation or limitations which is not specifically disclosed herein.

When a Markush group or other grouping is used herein, all individual members of the group and all combinations and subcombinations possible of the group are intended to be individually included in the disclosure.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

In general the terms and phrases used herein have their art-recognized meaning, which can be found by reference to standard texts, journal references and contexts known to those skilled in the art. The preceding definitions are provided to clarify their specific use in the context of the invention.

### EXAMPLE 1

### Growth of Silicon-Containing Nanowires and Nanocones

Substrates used were silicon wafers and stainless steel disks. Each stainless steel substrate was polished, cleaned and placed in a vacuum chamber. A thin coating of silicon, typically a few hundred nanometers thick, was deposited on the surface by magnetron sputter deposition in argon. Silicon wafers were generally used as received, with no special preparation. All substrates received a thin layer of indium (approximately 20 nanometers in thickness) prior to growth, either by evaporation or by magnetron sputtering.

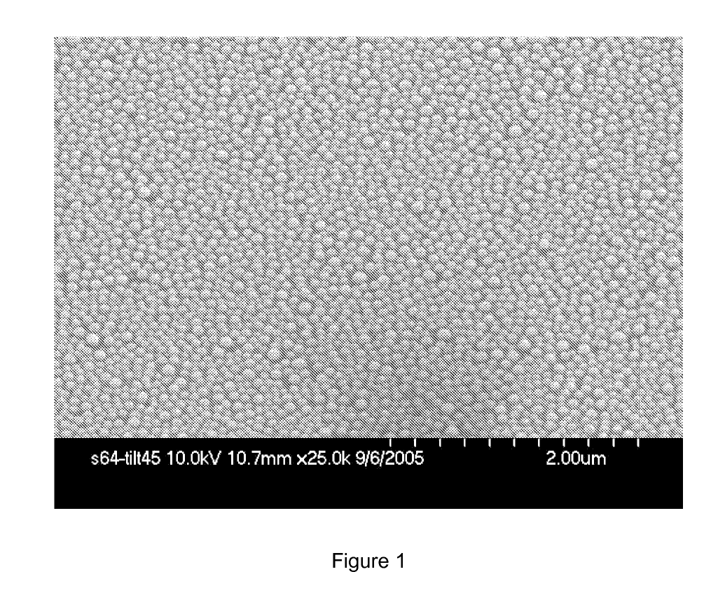

A lamp behind the substrate was used to maintain a temperature of about 180 degrees Celsius at the substrate. FIG. 1 illustrates the size of and distribution of indium droplets formed (after solidification of the droplets) on a silicon wafer with native oxide.

The magnetron faced the substrate at a separation of approximately 7 cm. For the samples shown in FIGS. 1, 2, 3, and 4, half the silicon magnetron surface was covered with an indium foil, resulting in the co-deposition of indium and silicon. The gas mixture was about 10% hydrogen in argon, with about 0.1% water vapor. The total pressure was about 30 milliTorr.

The substrate was biased at 600 to 1000 V negative with respect to the chamber wall, yielding a current of about 5 milliamperes drawn to the 2 inch diameter substrate and its holder, having a total surface area for ion collection roughly twice the area of the substrate alone. This current was observed while the 2 inch magnetron was operating at a current of about 25 milliamperes.

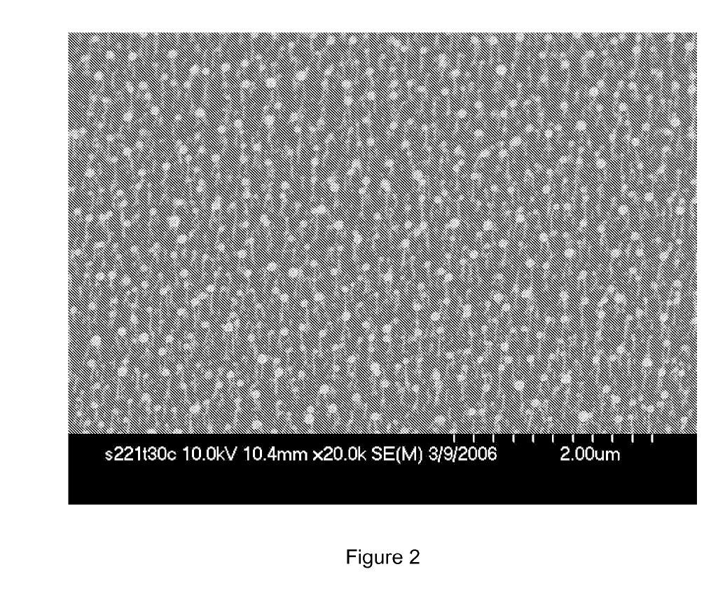

FIG. 2 illustrates the appearance of the substrate at an early stage in the growth process (4 min). The metal mediating particles are clearly visible on top of the nanowires.

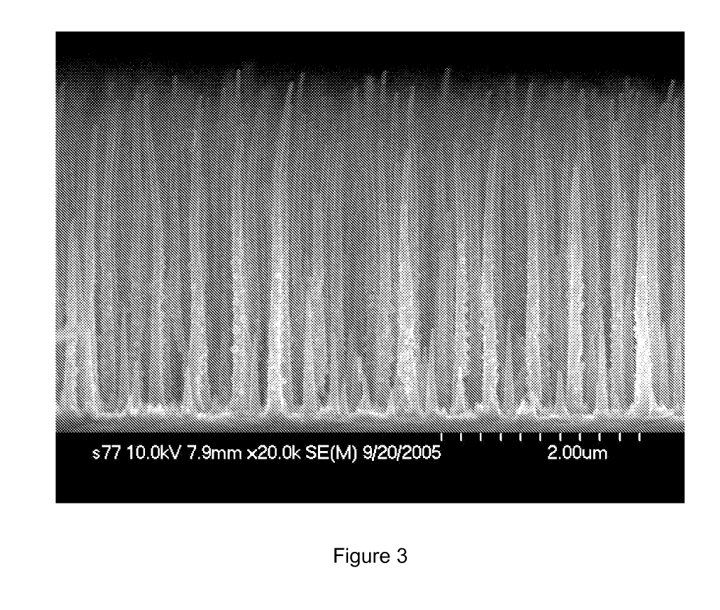

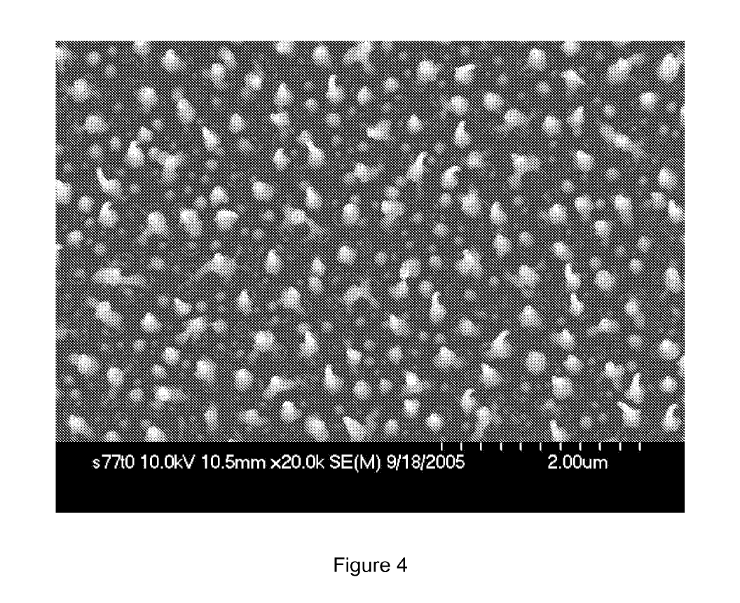

FIG. 3 illustrates nanocones formed at a later stage of the process (25 min). The maximum height of the nanocones reached was about 4 micrometers. For some of the nanocones, removal of the indium from the tips happened during growth. For other nanocones, small mediating particles remained at the tips (barely visible in this photo). Indium removal on the sidewalls was incomplete because cospuftering of indium with silicon continued to the end of the process. FIG. 4 is a normal incidence SEM image of the same sample as in FIG. 3. Some tips are bent, but the tip to base center distance is not much more than 200-300 nanometers.

When indium was not co-deposited with silicon, but the conditions were otherwise those described for the growth of the structures shown in FIG. 2, the nanostructures lost their indium and stopped growing after reaching a height of about 1 micrometer, and had a more wire-like appearance. However, by maintaining constant substrate current while increasing the gas pressure by approximately 30%, and increasing the magnetron current by 70%, nanostructure heights greater than 2 micrometers were obtained before the original indium was lost, without any co-deposition of indium. Using these conditions, substrate bias was reduced, resulting in a lower removal rate of indium by sputtering. The increased magnetron current is believed to lead to a higher silicon arrival rate at the sample, leading to faster growth of the nanostructures.

The samples shown in FIGS. 1-4 are believed to have at least some surface oxide.

### EXAMPLE 2

### Deposition of Additional Silicon onto Nanostructures

The silicon was supplied after the indium droplets were largely removed.

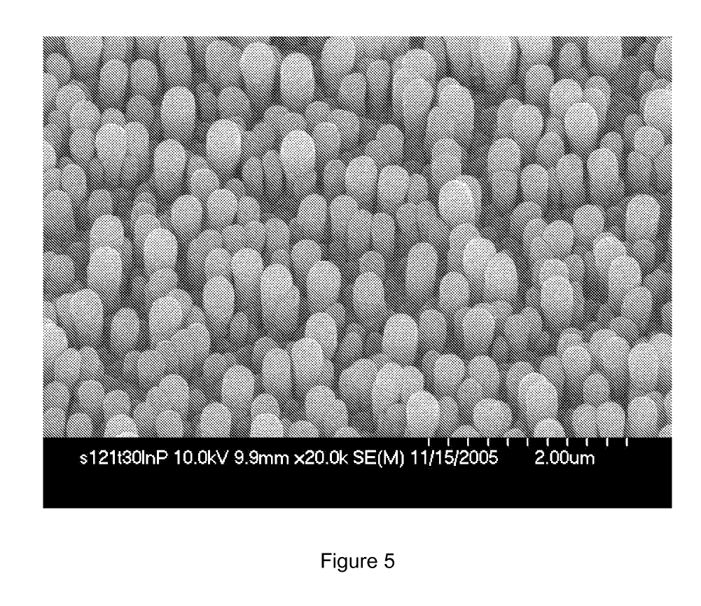

FIG. 5 is a top view, tilted 30 degrees away from normal incidence, of nanocones similar to those shown in FIG. 3 which have been processed with a subsequent Si sputter deposition step without hydrogen plasma etching. The nanostructures are now more cylindrical in shape and have rounded tips. For the additional deposition, the indium foil was removed from the silicon magnetron target. The gas environment was primarily argon, although traces of water vapor and atmospheric contaminants were always present. During the 30 minute period of additional deposition, the gas pressure was 24 mTorr, the sample temperature was held at 220 degrees Celsius, and the magnetron and sample stage currents were held at 50 milliAmperes and 1 milliAmpere, respectively. The substrate bias was 95 Volts.

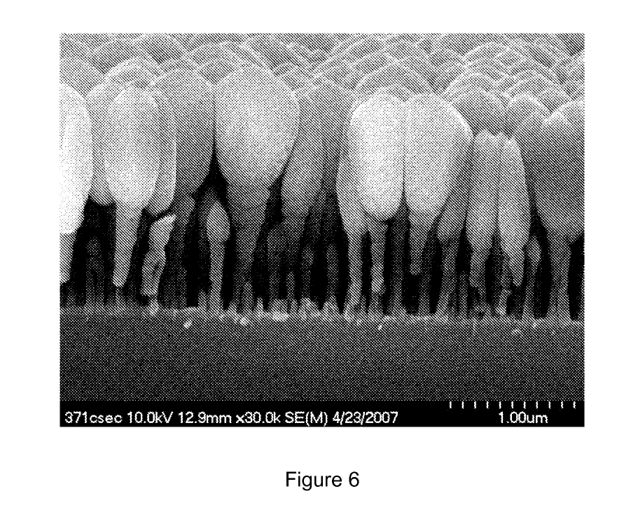

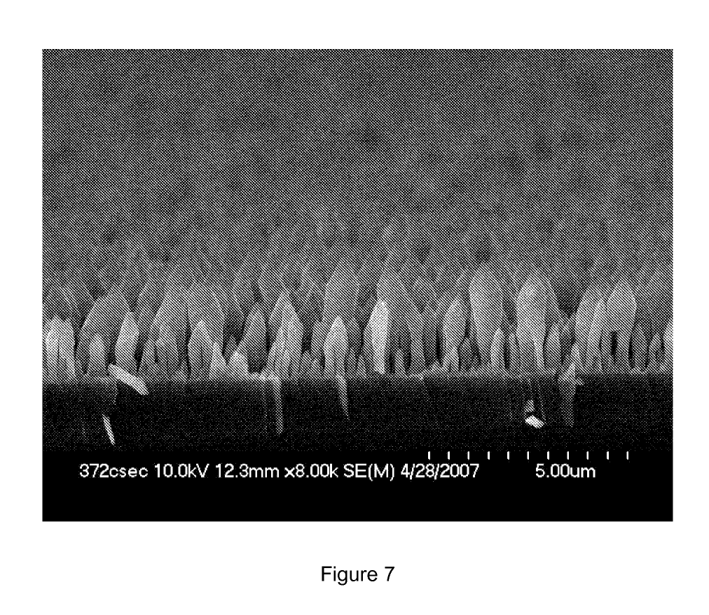

FIGS. 6 and 7 are micrographs of nanostructures produced similarly to those shown in FIG. 5, but using different conditions for the additional deposition step. The structures shown in FIG. 6 were formed through two hours of sputtering with a magnetron current of 50 milliAmperes, a sample stage current of 1 milliAmpere, and a gas environment of argon at 21 milliTorr. The magnetron target was silicon. The substrate bias was 120 Volts, and the substrate temperature was maintained at 140 degrees Celsius. The low temperature, low substrate bias, and low sample bombardment current are believed to have resulted in minimal redistribution of the silicon arriving at the nanocone tips, so silicon accumulated wherever it fell. The tops of the structures widened as they grew, soon shadowing each other and any objects below, including the substrate floor. Although the individual structures appear to be separated by visible boundaries, this image shows several examples of structures which lost their stems when the wafer was cleaved but remain attached to the mass of tightly-packed objects.

For the sample shown in FIG. 7, the additional deposition was performed in neon gas, rather than the argon gas used for all the other examples. The higher ionization potential of neon allowed operation at higher electrode potentials for similar currents within the deposition system. The magnetron was again operated at a current of 50 milliAmperes using a silicon target, but the sample stage current of 3 milliAmperes required a substrate potential of 1160 Volts. During the 2 hour deposition period, the gas pressure was maintained at 30 millitorr, and the sample temperature was approximately 30 degrees Celsius. Here, it is believed that the higher bombardment energies and currents resulted in much more redistribution of the incoming silicon. Unlike the example shown in FIG. 5, these nanostructures were thickened all the way to the substrate floor and most remained well separated from their neighbors. The sharply pointed tips and uniform cone angles are a direct result of the higher sputtering energies applied to this sample. Electron backscaftered diffraction (EBSD) and glancing-angle X-ray diffraction (GAXRD) were carried out on these augmented nanostructures to obtain information about the crystal structure. No crystalline phases were observed in the additionally deposited material.

1. A method of synthesizing an array of aligned elongated nanostructures, the method comprising the steps of:
a) providing a substrate in a vacuum chamber;
b) forming a layer of mediating material on a surface of the substrate, wherein the mediating material, when molten, forms droplets on the substrate surface;
c) heating said substrate and mediating material to a temperature sufficient to melt the mediating material in a vacuum atmosphere, the atmosphere comprising a component which is selected from the group consisting of noble gases, nitrogen and combinations thereof; and
d) synthesizing aligned elongated nanostructures of a selected chemical composition at the mediating material droplets, the nanostructures extending up from the substrate surface and being located generally under the mediating material droplets by
i) providing a source of each chemical element of the selected composition;
ii) generating a plasma in the vacuum chamber, thereby forming plasma species including positive ions; and
iii) inducing a negative electric potential on the substrate relative to the plasma, thereby directing positive ions towards the substrate surface.

2. The method of claim 1, wherein the nanostructures are not hollow.

3. The method of claim 1, wherein the substrate comprises an intermediate layer attached to a support, the layer of mediating material being formed on the intermediate layer.

4. The method of claim 1, wherein the mediating material is selected from the group consisting of indium, tin, gallium, bismuth, aluminum and alloys thereof.

5. The method of claim 1, wherein the substrate and mediating material are heated to a temperature less than or equal to 350° C.

6. The method of claim 1, wherein sputtering of a target provides a source of at least one element of the chemical composition of step d).

7. The method of claim 3, wherein the chemical composition of step d) comprises silicon, the intermediate layer is silicon and the mediating material comprises indium.

8. The method of claim 1, wherein the vacuum atmosphere further comprises water vapor.

9. The method of claim 1, wherein the vacuum atmosphere further comprises an etching component.

10. The method of claim 9, wherein the etching component comprises hydrogen.

11. The method of claim 1, wherein additional mediating material is deposited on the nanostructures during step d).

12. The method of claim 1, wherein after step d) droplets of mediating material remain at the tip of at least some of the nanostructures.

13. The method of claim 12, wherein after step d) the droplets are solidified and then removed.

14. The method of claim 1, further comprising the step of forming a layer of material on the nanostructures formed in step d), the material having a chemical composition similar to that of the nanostructures formed in step d).

15. The method of claim 1, further comprising the step of forming a layer of material on the nanostructures formed in step d), the material having a chemical composition substantially different than that of the nanostructures formed in step d).

16. A method for forming a structure, the method comprising a) forming an array of elongated nanostructures according to the method of claim 1; and
b) depositing at least one additional layer of material on the nanostructures, the additionally deposited layer joining the nanostructures of the array.

17. A method of synthesizing an array of aligned elongated nanostructures, the method comprising the steps of:
a) providing a substrate in a vacuum chamber;
b) forming a layer of mediating material on the substrate, wherein the mediating material, when molten, forms droplets on the substrate surface;
c) heating said substrate and the mediating material to a temperature sufficient to melt the mediating material and form mediating material droplets on the substrate surface; and
d) synthesizing aligned elongated nanostructures of a selected chemical composition at the mediating material droplets, the nanostructures extending up from the substrate surface and being located generally under the mediating material droplets by
i) providing a source of each chemical element of the selected composition; and
ii) directing an ion beam at said substrate surface, said beam having ion energies in the range of 10 eV to 5 keV.

18. The method of claim 17, wherein the nanostructures are not hollow.

19. The method of claim 17, wherein the substrate comprises an intermediate layer attached to a support, the layer of mediating material being formed on the intermediate layer.

20. The method of claim 17, wherein the mediating material is selected from the group consisting of indium, tin, gallium, bismuth, aluminum and alloys thereof.

21. The method of claim 17, wherein the substrate and mediating material are heated to a temperature less than or equal to 350° C.

22. The method of claim 17, wherein the chemical composition of step d) comprises silicon, the intermediate layer is silicon, and the mediating material comprises indium.

23. The method of claim 17, wherein the vacuum atmosphere further comprises water vapor.

24. The method of claim 17, wherein the vacuum atmosphere further comprises an etching component.

25. The method of claim 24, wherein the etching component comprises hydrogen.

26. The method of claim 17, wherein additional mediating material is deposited on the nanostructures during step d).

27. The method of claim 17, wherein after step d) droplets of mediating material remain at the tip of at least some of the nanostructures.

28. The method of claim 27, wherein after step d) the droplets are solidified and then removed.

29. The method of claim 17, further comprising the step of forming a layer of material on the nanostructures formed in step d), the material having a chemical composition similar to that of the nanostructures formed in step d).

30. The method of claim 17, further comprising the step of forming a layer of material on the nanostructures formed in step d), the material having a chemical composition substantially different than that of the nanostructures formed in step d).

31. A method for forming a structure, the method comprising:
a) forming an array of elongated nanostructures according to the method of claim 17; and
b) depositing at least one additional layer of material on the nanostructures, the additionally deposited layer joining the nanostructures of the array.
